(19) United States
(12) Patent Application Publication
(10) Pub. No.: US 2026/0139157 A1
(43) Pub. Date: May 21, 2026

(54) THERMAL-AND-UV-CURABLE (METH)ACRYLATE COMPOSITION

(71) Applicant: Henkel AG & Co. KGaA, Duesseldorf (DE)

(72) Inventors: Weihao Zhang, Shanghai (CN); Zheng Shi, Shanghai (CN); Xiaolong Hu, Shanghai (CN); Cuirui Luo, Shanghai (CN); Bin Zhao, Shanghai (CN); Haoran Hu, Shanghai (CN)

(21) Appl. No.: 19/448,710

(22) Filed: Jan. 14, 2026

Related U.S. Application Data
(63) Continuation of application No. PCT/CN2023/108031, filed on Jul. 19, 2023.

(51) Int. Cl. C09J 4/06; C09J 11/08; C09J 135/02

(52) U.S. Cl. CPC C09J 4/06; C09J 11/08; C09J 135/02

(57) ABSTRACT

The present invention provides a thermal- and UV-curable (meth)acrylate composition comprising:
(A) an epoxy resin,
(B) a (meth)acrylate,
(C) a photoinitiator,
(D) a thiol curing agent, and
(E) a catalyst mixture containing (e-1) an epoxy-adduct polyamine, (e-2) a microcapsule type hardener for an epoxy resin comprising a core and a shell, and (e-3) a urea-modified imidazole, wherein the weight ratio of the component (e-2) to the component (e-3) is not lower than 2.1. The present invention also provides a method for preparing the composition, a method for curing the composition, a cured product obtained from the composition or by the curing method, an article comprising the cured product, and a use of the composition or the cured product in assembling a camera module.

### TECHNICAL FIELD

The present invention relates to a thermal- and UV-curable (meth)acrylate composition and particularly relates to a thermal- and UV-curable (meth)acrylate composition which can be cured at a low temperature such as 65° C., achieves a good balance between the curing performance at the low temperature and the storage stability at room temperature, and shows good anti-aging properties; a method for preparing the composition, a method for curing the composition, a cured product obtained from the composition or by the curing method, an article comprising the cured product, and a use of the composition or the cured product in assembling a camera module.

### BACKGROUND OF THE INVENTION

Currently, most of the materials used for image sensor modules in camera modules of mobile devices such as cameras, smartphones, and pads are thermosensitive plastics; and high temperatures such as 80° C., which is a common curing temperature of current adhesives, can easily damage the components therein. Moreover, when an adhesive is used at high temperatures in mobile devices, there will be a lot of volatile substances escaping from the adhesive, and these volatile substances may attach to sensors, lenses, etc., causing damage to the sensors, lenses, etc., and pollution. Furthermore, with an increasing demand for camera imaging, the demand for low-temperature curable adhesives is also increasing. In addition, adhesives in prior art do not have good anti-aging properties; for example, both the ratio of the decrease in the adhesion after a double 85 test (85° C. and 85% relative humidity) for 240 hours to the initial adhesion, and the ratio of the decrease in the adhesion after a double 85 test for 500 hours to the initial adhesion are higher than 30%. In view of the above facts, an adhesive which can be cured at a low temperature such as temperatures equal to or lower than 65° C., and has good anti-aging properties is needed.

However, it takes a long time for moisture- and UV-curable adhesives to be cured totally, which will negatively affect production efficiency; UV-curable adhesives are not usable for bonding portions that cannot be irradiated by UV, resulting in poor curing; and currently available thermal- and UV-low-temperature (65° C./1 h) curable adhesives, especially one-component adhesives, often have poor storage stabilities.

In view of the above, it would be desirable to provide a thermal- and UV-curable (meth)acrylate composition which can be cured at a low temperature such as 65° C., achieves a good balance between the curing performance at the low temperature and the storage stability at room temperature, and shows good anti-aging properties.

### SUMMARY OF THE INVENTION

The present invention provides a thermal- and UV-curable (meth)acrylate composition comprising:
(A) an epoxy resin,
(B) a (meth)acrylate,
(C) a photoinitiator,
(D) a thiol curing agent, and
(E) a catalyst mixture containing (e-1) an epoxy-adduct polyamine, (e-2) a microcapsule type hardener for an epoxy resin comprising a core and a shell, and (e-3) a urea-modified imidazole, wherein the weight ratio of the component (e-2) to the component (e-3) is not lower than 2.1.

The present invention also provides a method for preparing the thermal- and UV-curable (meth)acrylate composition according to the present invention, comprising: (1) firstly, adding the components (A) to (D) into a container, and mixing and defoaming the resultant mixture; (2) then, adding the components (e-1) and (e-2) into the container, and mixing and defoaming the resultant mixture; and (3) finally, adding the component (e-3) into the container, and mixing and defoaming the resultant mixture, to obtain the thermal- and UV-curable (meth)acrylate composition.

The present invention further provides a method for curing the thermal- and UV-curable (meth)acrylate composition according to the present invention, comprising: (1) irradiating the composition with UV to obtain a pre-cured composition, and then (2) curing the pre-cured composition by heating.

In addition, the present invention provides a cured product obtained from the thermal- and UV-curable (meth)acrylate composition according to the present invention or by the curing method according to the present invention.

Moreover, the present invention provides an article comprising the cured product according to the present invention.

Furthermore, the present invention provides a use of the thermal- and UV-curable (meth)acrylate composition according to the present invention or the cured product according to the present invention in assembling a camera module.

All of the thermal- and UV-curable (meth)acrylate composition, the preparing method, the curing method, the cured product, the article, and the use according to the present invention are based on the following surprising discoveries of the inventors: the thermal- and UV-curable (meth)acrylate composition according to the present invention, which utilizes a specific combination of three kinds of catalysts (i.e. the components (e-1), (e-2) and (e-3)) in an epoxy-(meth)acrylic/thiol system, can be cured at a low temperature such as 65° C., achieves a good balance between the curing performance at the low temperature and the storage stability at room temperature, and shows good anti-aging properties; and in particular, it achieves a curing ratio higher than 90% within one hour at 65° C., ensures a viscosity growth rate equal to or lower than 30% after three days at 25° C., and shows a ratio of the decrease in the adhesion after a double 85 test for 240 hours to the initial adhesion, and a ratio of the decrease in the adhesion after a double 85 test for 500 hours to the initial adhesion both of which are lower than 30%.

### DETAILED DESCRIPTION OF THE INVENTION

It is to be understood by one of ordinary skill in the art that the present discussion is a description of exemplary embodiments only and is not intended as limiting the broader aspects of the present invention. Each aspect so described may be combined with any other aspect or aspects unless clearly indicated to the contrary. In particular, any feature indicated as being preferred or advantageous may be combined with any other feature or features indicated as being preferred or advantageous.

Unless specified otherwise, as used herein, the terms “a”, “an” and “the” include both singular and plural referents. That is to say, the terms “a”, “an” and “the” are used interchangeably with “at least one” to mean one or more of the elements being described.

The terms “comprising” and “comprises” as used herein are synonymous with “including”, “includes”, “containing” or “contains”, and are inclusive or open-ended and do not exclude additional, non-recited members, elements, or process steps.

Unless specified otherwise, the recitation of numerical end points includes all numbers and fractions subsumed within the respective ranges, as well as the recited end points.

Unless specified otherwise, all the term “room temperature” used herein refers to 23±2° C.

Unless otherwise defined, all terms used in disclosing the invention, including technical and scientific terms, have the meaning as commonly understood by one of the ordinary skills in the art to which this invention belongs.

According to the present invention, surprisingly, the inventors of the present invention found that a thermal- and UV-curable (meth)acrylate composition comprising:
(A) an epoxy resin,
(B) a (meth)acrylate,
(C) a photoinitiator,
(D) a thiol curing agent, and
(E) a catalyst mixture containing (e-1) an epoxy-adduct polyamine, (e-2) a microcapsule type hardener for an epoxy resin comprising a core and a shell, and (e-3) a urea-modified imidazole, wherein the weight ratio of the component (e-2) to the component (e-3) is not lower than 2.1, which can be cured at a low temperature such as 65° C., achieves a good balance between the curing performance at the low temperature and the storage stability at room temperature, and shows good anti-aging properties.

In the first aspect, the present disclosure is generally directed to a thermal- and UV-curable (meth)acrylate composition comprising:
(A) an epoxy resin,
(B) a (meth)acrylate,
(C) a photoinitiator,
(D) a thiol curing agent, and
(E) a catalyst mixture containing (e-1) an epoxy-adduct polyamine, (e-2) a microcapsule type hardener for an epoxy resin comprising a core and a shell, and (e-3) a urea-modified imidazole, wherein the weight ratio of the component (e-2) to the component (e-3) is not lower than 2.1.

### (A) Epoxy Resin

According to the present invention, the thermal- and UV-curable (meth)acrylate composition comprises (A) an epoxy resin.

The epoxy resin which can be used in the composition according to the present invention is not particularly limited. Examples thereof include bisphenol A-type epoxy resin, bisphenol F-type epoxy resin, bisphenol S-type epoxy resin, 2,2′-diallyl bisphenol A-type epoxy resin, hydrogenated bisphenol-type epoxy resin, propylene oxide addition bisphenol A-type epoxy resin, resorcinol-type epoxy resin, bisphenyl-type epoxy resin, sulfide-type epoxy resin, diphenyl ether-type epoxy resin, dicyclopentadiene-type epoxy resin, naphthalene-type epoxy resin, phenol novolac-type epoxy resin, naphthalene phenol novolac-type epoxy resin, glycidyl amine-type epoxy resin, alkyl polyol-type epoxy resin, rubber-modified-type epoxy resin, glycidyl ester compounds, and bisphenol A-type episulfide resin. Preferably, the epoxy resin is a bisphenol A-type epoxy resin and/or a bisphenol F-type epoxy resin. More preferably, the epoxy resin is a bisphenol A-type epoxy resin.

Examples of commercially available epoxy resin include, but are not limited to: EPICLON 850-S and 830-S, both of which are available from DIC Corporation; EP-4000S, EP-4000L, EP-4003S and EP-4010S, all of which are available from ADEKA Corporation; and jER-828US and jER-YL983U, both of which are available from Mitsubishi Chemical Corporation. Preferably, component (A) is jER-828US available from Mitsubishi Chemical Corporation.

Preferably, the amount of component (A) is from 5 to 30 wt. %, and preferably from 8 to 25 wt. %, each based on the total weight of the composition. When the amount of component (A) is within the above ranges, the composition prepared therefrom has a better adhesive force.

Preferably, the component (A) in the present invention does not cover an epoxy resin which contains a (meth)acrylate group.

### (B) (Meth)acrylate

According to the present invention, the thermal- and UV-curable (meth)acrylate composition comprises (B) a (meth)acrylate.

In the present specification, terms “(meth)acrylate”, “(meth)acrylic” and “(meth)acryloyl group” refer to either or both of an acrylate and an methacrylate, either or both of acrylic and methacrylic, and either or both of acryloyl group and methacryloyl group respectively.

The (meth)acrylate which can be used in the composition according to the present invention is not specifically limited, and it may be a monofunctional (meth)acrylate and/or a polyfunctional (meth)acrylate.

Examples of monofunctional (meth)acrylates include dicyclopentandienyl (meth)acrylate, methyl (meth)acrylate, ethyl (meth)acrylate, n-propyl (meth)acrylate, isobornyl (meth)acrylate, 2-(meth)acryloxyethyl trimethoxysilane, 2-(meth)acryloxyethyl triethoxysilane, 3-(meth)acryloxypropyl trimethoxysilane, 3-(meth)acryloxypropyl methyl dimethoxysilane, 3-(meth)acryloxypropyl triethoxysilane, 3-(meth)acryloxymethyl diethoxysilane, 4-(meth)acryloxybutyl trimethoxysilane, 4-(meth)acryloxybutyl triethoxysilane, dicyclopentenyloxyethyl (meth)acrylate, dicyclopentanyl (meth)acrylate, pentamethyl piperidyl (meth)acrylate, tetramethyl piperidyl (meth)acrylate, methoxypolyethylene glycol (meth)acrylate, benzyl (meth)acrylate, 2-hydroxy-3-acryloyloxypropyl (meth)acrylate, 2-(meth)acryloyloxyethyl phthalate, methoxypolyethylene glycol (meth)acrylate, phenoxyethylene glycol (meth)acrylate, stearyl (meth)acrylate, and 2-(meth)acryloloxyethyl succinate.

Examples of difunctional (meth)acrylates include dipropylene glycol di(meth)acrylate, tricyclodecane dimethanol di (meth)acrylate, 1,4-butanediol di(meth)acrylate, neopentyl glycol di(meth)acrylate, polyethylene glycol #200 di(meth)acrylate, EO-modified bisphenol A di(meth)acrylate, EO-modified polypropylene glycol #700 di (meth)acrylate, ethylene glycol di(meth)acrylate, diethylene glycol di(meth)acrylate, triethylene glycol di(meth)acrylate, polyethylene glycol di(meth)acrylate, 2,2-bis[4-((meth)acryloxy-ethoxy)phenyl]propane, ethoxylated bisphenol A di(meth)acrylate, 1,10-decanediol di(meth)acrylate, 1,6-hexanediol di(meth)acrylate, 1,9-nonanediol di(meth)acrylate, neopentylglycol di(meth)acrylate, ethoxylated polypropylene glycol di(meth)acrylate, and polypropylene glycol di(meth)acrylate. Examples of trifunctional (meth)acrylates include trimethylolpropane tri(meth)acrylate.

The thermal- and UV-curable (meth)acrylate composition according to the present invention may comprise a single type or a combination of two or more types of the (meth)acrylate. Preferably, the inventive composition comprises a mixture of a monofunctional (meth)acrylate and a difunctional (meth)acrylate.

In a preferable embodiment of the present invention, the (meth)acrylate is dicyclopentandienyl methacrylate and/or tricyclodecane dimethanol diacrylate. More preferably, the (meth)acrylate is a mixture of dicyclopentandienyl methacrylate and tricyclodecane dimethanol diacrylate.

Examples of commercially available (meth)acrylates include, but are not limited to: CD535 and SR833S, both of which are available from Sartomer; IBXA available from Osaka Organic Chemical Industry Ld.; FA-023M, FA-124M, FA-125, FA-220M, FA-321M, FA-512M, FA-513M, FA-711MM, FA-712HM, methoxypolyethylene glycol (meth)acrylate, and FA-BZM, all of which are available from Hitachi Chemical Co., Ltd; Light Ester G-201P, available from Kyoeisha Chemical Co., Ltd.; CB-1, PHE-1G, S, SA, TMPT, A-DCP, APG-100, 1G, 2G, 3G, polyethylene glycol di(meth)acrylate, BPE-80N, BCP, ethoxylated bisphenol A di(meth)acrylate, DCP, DOD-N, HD-N, NOD-N, NPG, ethoxylated polypropylene glycol di(meth)acrylate, and polypropylene glycol dimethyacrylate, all of which are available from Shin-Nakamura Chemical Co., Ltd. Preferably, the (meth)acrylate is selected from the group consisting of CD535 and SR833S, both of which are available from Sartomer; IBXA available from Osaka Organic Chemical Industry Ld.; and A-DCP and DCP, both of which are available from Shin-Nakamura Chemical Co., Ltd. More preferably, the (meth)acrylate is a mixture of CD535 and SR833S, both of which are available from Sartomer.

Preferably, the amount of component (B) is from 5 to 50 wt. %, preferably from 15 to 40 wt. %, and more preferably from 20 to 30 wt. %, each based on the total weight of the composition. When the amount of component (B) is within the above ranges, the composition prepared therefrom has a better initial bonding under UV, which can be used for temporary fixing.

Preferably, the component (B) in the present invention does not cover a (meth)acrylate which contains an epoxy group.

### (C) Photoinitiator

According to the present invention, the thermal- and UV-curable (meth)acrylate composition comprises (C) a photoinitiator.

The photoinitiator which can be used in the composition according to the present invention is not specifically limited, and those typically used in the art can be used. Examples thereof include, but are not limited to: 2,2-dimethoxy-1,2-diphenyl ethan-1-one, 1-hydroxy-cyclohexyl-phenyl-ketone, 1-[4-(2-hydroxyethoxy)-phenyl]-2-hydroxy-2-methyl-1-propane-1-one, 2-methyl-1-[4-(methylthio)phenyl]-2-morpholinopropane-1-one, 2-benzyl-2-dimethylamino-1-(4-morpholinophenyl)-1-buthanone, bis(2,4,6-trimethylbenzoyl)phenylphosphine oxide, 2-hydroxy-1-4-[4-(2-hydroxy-2-methyl-propionyl)-benzyl]-phenyl}-2-methyl-propane, 1,2-octanedione 1-[4-(phenylthio)-2-(O-benzoyloxime)], 2-hydroxy-2-methyl-1-phenyl-propane-1-one, phenylglyoxylic acid methyl ester, and 2,4,6-trimethylbenzoyl-diphenyl-phosphine oxide.

Examples of commercially available photoinitiators include, but are not limited to: OMNIRAD 1000, 248, OMNIRAD 481, OMNIRAD 4817, OMNIRAD 4MBZ-flakes, OMNIRAD 500, OMNIRAD 659, OMNIRAD 73, OMNIRAD 784, OMNIRAD 81, O MNIRAD BDK, OMNIRAD MBS, OMNIRAD BP-flakes, OMNIRAD DETX, OMNIRAD EDB, OMNIRAD EHA, OMNIRAD EMK, OMNIRA D ITX, OMNIRAD MBF, OMNIRAD OMBB, OMNIRAD TPO, OMNIRAD 410, OMNIRAD BL723, OMNIRAD BL724, OMNIRAD BL750, OMNIRAD BL751, OMNIRAD 1173, OM NIRAD 127, OMNIRAD 184, OMNIRAD 184FF, OMNIRAD 2022, OMNIRAD 2100, OMNIRAD 2959, OMNIRAD 369, OMNIRAD369E, OMNIRAD 379, OMNIRAD 379EG, OMNIRAD 4265, OMNIRAD 754, OMNIRAD 819, OMNIRAD 819DW, OMNIRAD 907, OMNIRAD 907FF, OMNIRAD BP, OMNIRAD 127D, ESACURE 1001M, ESACURE ONE, ESACUREA198, ESACURE KIP 160, ESACURE KIP 150, ESACURE KIP 100F, ESACURE KIP-LT, ESACURE KIP-IT, ESACURE KTO-46, ESACURE DP-250, ESACURE TZT, and ESACURE KT-55 (all of which are available from IGM Resins). Preferably, the photoinitiator is OMNIRAD 2100 available from IGM Resins.

Preferably, the amount of component (C) is from 0.5 to 5 wt. %, and preferably from 1.5 to 3.5 wt. %, each based on the total weight of the composition. When the amount of component (C) is within the above ranges, the composition prepared therefrom has a better initial bonding under UV, which can be used for temporary fixing.

### (D) Thiol Curing Agent

According to the present invention, the thermal- and UV-curable (meth)acrylate composition comprises (D) a thiol curing agent.

The thiol curing agent which can be used in the composition according to the present invention is not specifically limited, and those typically used in the art can be used. Preferably, the thiol curing agent is a polythiol compound.

Examples of polythiol compounds include, but are not limited to:
pentaerythritol tetrakis(3-mercaptopropionate), pentaerythritol tetrakis(thioglycolate), dipentaerythritol hexakis(3-mercaptopropionate), dipentaerythritol hexakis(3-mercaptobutyrate), 1,3,4,6-tetrakis (2-mercaptoethyl)-1,3,4,6-tetraazaoctahydropentalene-2,5-dione, 1,3,5-tris(3-mercaptopropyl)-1,3,5-triazine-2,4,6 (1H,3H,5H)-trione, 4-mercaptomethyl-1,8-dimercapto-3,6-dithiaoctane, 4,8-, 4,7- or 5,7-dimercaptomethyl-1,11-dimercapto-3,6,9-trithiaundecane, 1,3,4,6-tetrakis (2-mercaptoethyl)glycoluril, 1,2,3-tris(mercaptomethylthio propane, 1,2,3-tris(2-mercaptoethylthio)propane, 1,2,3-tris(3-mercaptopropylthio)propane, 4-mercaptomethyl-1,8-dimercapto-3,6-dithiaoctane, 5,7-dimercaptomethyl-1,11-dimercapto-3,6,9-trithiaundecane, 4,7-dimercaptomethyl-1,11-dimercapto-3,6,9-trithiaundecane, 4,8-dimercaptomethyl-1,11-dimercapto-3,6,9-trithiaundecane, tetrakis(mercaptomethylthiomethyl)methane, tetrakis(2-mercaptoethylthiomethyl)methane, tetrakis(3-mercaptopropylthiomethyl)methane, 1,1,3,3-tetrakis(mercaptomethylthio)propane, 1,1,2,2-tetrakis(mercaptomethylthio)ethane, 4,6-bis(mercaptomethylthio)-1,3-dithiane, 1,1,5,5-tetrakis(mercaptomethylthio)-3-thiapentane, 1,1,6,6-tetrakis (mercaptomethylthio)-3,4-dithiahexane, 2,2-bis(mercaptomethylthio) ethane thiol, 3-mercaptomethylthio-1,7-dimercapto-2,6-dithiaheptane, 3,6-bis(mercaptomethylthio)-1,9-dimercapto-2,5,8-trithianonane, 3-mercaptomethylthio-1,6-dimercapto-2,5-dithiahexane, 1,1,9,9-tetrakis (mercaptomethylthio)-5-(3,3-bis(mercaptomethylthio)-1-thiapropyl) 3,7-dithianonane, tris(2,2-bis(mercaptomethylthio)ethyl)methane, tris(4,4-bis(mercaptomethylthio)-2-thiabutyl)methane, tetrakis(2,2-bis(mercaptomethylthio)ethyl)methane, tetrakis(4,4-bis(mercaptomethylthio)-2-thiabutyl)methane, 3,5,9,11-tetrakis(mercaptomethylthio)-1,13-dimercapto-2,6,8,12-tetrathiatridecane, 3,5,9,11,15,17-hexakis(mercaptomethylthio)-1,19-dimercapto-2,6,8,12,14,18-hexathianonadecane, 9-(2,2-bis(mercaptomethylthio)ethyl)-3,5,13,15-tetrakis(mercaptomethylthio)-1,17-dimercapto-2,6,8,10,12,16-hexathiaheptadecane, 3,4,8,9-tetrakis(mercaptomethylthio)-1,11-dimercapto-2,5,7,10-tetrathiaundecane, 3,4,8,9,13,14-hexakis(mercaptomethylthio)-1,16-dimercapto-2,5,7,10,12,15-hexathiahexadecane, 8-[bis(mercaptomethylthio)methyl]-3,4,12,13-tetrakis(mercaptomethylthio)-1,15-dimercapto-2,5,7,9,11,14-hexathiapentadecane, 4,6-bis[3,5-bis(mercaptomethylthio)-7-mercapto-2,6-dithiaheptylthio]-1,3-dithiane, 4-[3,5-bis(mercaptomethylthio)-7-mercapto-2,6-dithiaheptylthio]-6-mercaptomethylthio-1,3-dithiane, 1,1-bis[4-(6-mercaptomethylthio)-1,3-dithianylthio]-1,3-bis(mercaptomethylthio)propane, 1-[4-(6-mercaptomethylthio)-1,3-dithianylthio]-3-[2,2-bis(mercaptomethylthio)ethyl]-7,9-bis (mercaptomethylthio)-2,4,6,10-tetrathiaundecane, 1,5-bis[4-(6-mercaptomethylthio)-1,3-dithianylthio]-3-[2-(1,3-dithietanyl)]methyl-2,4-dithiapentane, 3-[2-(1,3-dithietanyl)]methyl-7,9-bis (mercaptomethylthio)-1,11-dimercapto-2,4,6,10-tetrathiaundecane, 9-[2-(1,3-dithietanyl)]methyl-3,5,13,15-tetrakis(mercaptomethylthio)-1,17-dimercapto-2,6,8,10,12,16-hexathiaheptadecane, 3-[2-(1,3-dithietanyl)]methyl-7,9,13,15-tetrakis (mercaptomethylthio)-1,17-dimercapto-2,4,6,10,12,16-hexathiaheptadecane, 3,7-bis[2-(1,3-dithietanyl)]methyl-1,9-dimercapto-2,4,6,8-tetrathianonane, 4,6-bis {3-[2-(1,3-dithietanyl)]methyl-5-mercapto-2,4-dithiapentylthio}-1,3-dithiane, 4,6-bis[4-(6-mercaptomethylthio)-1,3-dithianylthio]-6-[4-(6-mercaptomethylthio)-1,3-dithianylthio]-1,3-dithiane, 4-[3,4,8,9-tetrakis (mercaptomethylthio)-11-mercapto-2,5,7,10-tetrathiaundecyl]-5-mercaptomethylthio-1,3-dithiolane, 4,5-bis[3,4-bis(mercaptomethylthio)-6-mercapto-2,5-dithiahexylthio]-1,3-dithiolane, 4-[3,4-bis (mercaptomethylthio)-6-mercapto-2,5-dithiahexylthio]-5-mercaptomethylthio-1,3-dithiolane, 4-[3-bis(mercaptomethylthio)methyl-5,6-bis (mercaptomethylthio)-8-mercapto-2,4,7-trithiaoctyl]-5-mercaptomethylthio-1,3-dithiolane, 2-{bis[3,4-bis(mercaptomethylthio)-6-mercapto-2,5-dithiahexylthio]methyl}-1,3-dithietane, 2-[3,4-bis(mercaptomethylthio)-6-mercapto-2,5-dithiahexylthio]mercaptomethylthiomethyl-1,3-dithietane, 2-[3,4,8,9-tetrakis(mercaptomethylthio)-11-mercapto-2,5,7,10-tetrathiaundecylthio]mercaptomethylthiomethyl-1,3-dithietane, 2-[3-bis(mercaptomethylthio)methyl-5,6-bis (mercaptomethylthio)-8-mercapto-2,4,7-trithiaoctyl]mercaptomethylthiomethyl-1,3-dithietane, 4,5-bis {1-[2-(1,3-dithietanyl)]-3-mercapto-2-thiapropylthio}-1,3-dithiolane, 4-{1-[2-(1,3-dithietanyl)]-3-mercapto-2-thiapropylthio}-5-[1,2-bis (mercaptomethylthio)-4-mercapto-3-thiabutylthio]-1,3-dithiolane, 2-{bis[4-(5-mercaptomethylthio-1,3-dithiolanyl)thio]methyl}-1,3-dithietane, and 4-[4-(5-mercaptomethylthio-1,3-dithiolanyl)thio]-5-{1-[2-(1,3-dithietanyl)]-3-mercapto-2-thiapropylthio}-1,3-dithiolane. In the present invention, one of the aforementioned polythiol compounds may be used singly, or two or more types thereof may be used in combination.

Preferably, the thiol curing agent is pentaerythritol tetrakis(3-mercaptopropionate) and/or 1,3,5-tris(3-mercaptopropyl)-1,3,5-triazine-2,4,6 (1H,3H,5H)-trione. More preferably, the thiol curing agent is 1,3,5-tris(3-mercaptopropyl)-1,3,5-triazine-2,4,6 (1H,3H,5H)-trione.

Examples of commercially available thiol curing agents include, but are not limited to: TS-G available from Shikoku Chemicals Corporation; DPMP and PEMP available from SC Organic Chemical Co., Ltd.; PETG available from Yodo Kagaku Co., Ltd; and Multhiol Y-4 and Multhiol K-3, both of which are available from SC Organic Chemical Co., Ltd. Preferably, the thiol curing agent is selected from the group consisting of Multhiol Y-4 and Multhiol K-3, both of which are available from SC Organic Chemical Co., Ltd. More preferably, the thiol curing agent is Multhiol K-3, available from SC Organic Chemical Co., Ltd.

Preferably, the amount of component (D) is from 5 to 50 wt. %, preferably from 15 to 40 wt. %, and more preferably from 25 to 35 wt. %, each based on the total weight of the composition. When the amount of component (D) is within the above ranges, the composition prepared therefrom has a better adhesive force and a better hydrolysis resistance.

### (E) Catalyst Mixture

According to the present invention, the thermal- and UV-curable (meth)acrylate composition comprises (E) a catalyst mixture containing (e-1) an epoxy-adduct polyamine, (e-2) a microcapsule type hardener for an epoxy resin comprising a core and a shell, and (e-3) a urea-modified imidazole, wherein the weight ratio of the component (e-2) to the component (e-3) is not lower than 2.1.

Preferably, the weight ratio of the component (e-2) to the component (e-3) is from 2.1 to 25, preferably from 2.2 to 20, and more preferably from 2.3 to 15. If such a weight ratio is lower than 2.1, the thermal- and UV-curable (meth)acrylate composition cannot achieve a good balance between the curing performance at the low temperature and the storage stability at room temperature.

(e-1) Epoxy-Adduct Polyamine

According to the present invention, the thermal- and UV-curable (meth)acrylate composition comprises (e-1) an epoxy-adduct polyamine. Preferably, the component (e-1) is obtained from (e-1-1) an amine compound and (e-1-2) an epoxy compound.

In an embodiment of the present invention, preferably, the amine compound (e-1-1) comprises an N,N-dialkylaminoalkylamine represented by formula (I)

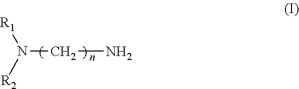

wherein R₁ and R₂ each represent an alkyl group having 1 to 8 carbon atoms, or R₁ and R₂ are connected together to form an alkylene group which optionally contains an oxygen atom or a nitrogen atom; and n represents 1 to 6.

In formula (I), the alkyl group as represented by R₁ or R₂ includes methyl, ethyl, propyl, butyl, pentyl, hexyl, heptyl and octyl groups. When taken together, R₁ and R₂ can represent an alkylene group which may contain an oxygen atom or a nitrogen atom. For example, R₁ and R₂ can be taken together with the nitrogen atom to which they are bonded to form a heterocyclic ring, such as a morpholine ring, a piperidine ring or a piperazine ring.

Examples of the N, N-dialkylaminoalkylamine represented by formula (I) include N,N-dimethylaminopropylamine, N, N-diethylaminopropylamine, N,N-dipropylaminopropylamine, N,N-dibutylaminopropylamine, N,N-dimethylaminoethylamine, N, N-diethylaminoethylamine, N, N-dimethylaminobutylamine, aminopropylmorpholine, aminoethylpiperidine, and 1-(2-aminoethyl)-4-methylpiperazine.

The N, N-dialkylaminoalkylamine represented by formula (I) can be used in combination with other amine compounds, such as monoamines, e.g., benzylamine and cyclohexylamine; and polyamines, e.g., diethylenetriamine, triethylenetetramine, tetraethylenepentamine, 1,2-diamino-propane, 1,2-diaminocyclohexane, 1,4-diamino-3,6-diethyl-cyclohexane, isophoronediamine, m-xylylenediamine, diaminodiphenylmethane, diaminodiphenylsulfone, and piperazine. Preferably, in addition to the N, N-dialkylaminoalkylamine represented by formula (I), the amine compound (e-1-1) further comprises at least one amine compound selected from isophoronediamine, m-xylylenediamine, and hexamethylenediamine.

In another embodiment of the present invention, preferably, useful epoxy compounds as component (e-1-2) include polyglycidyl ethers, such as bisphenol A and bisphenol F; polyepoxy compounds, such as tetraglycidyl m-xylylenediamine, diglycidylaniline, and diglycidyl o-toluidine; and monoepoxy compounds, such as phenyl glycidyl ether, methylphenyl glycidyl ether, and butylphenyl glycidyl ether. More preferably, the component (e-1-2) is at least one epoxy compound selected from tetraglycidyl m-xylylenediamine and diglycidyl o-toluidine.

Preferably, in preparing the component (e-1), the epoxy compound (e-1-2) is used in an amount corresponding to 0.5 to 2 epoxy groups per NH₂ of the amine compound (e-1-1).

Examples of commercially available epoxy-adduct polyamines include, but are not limited to: EH-4357S, EH-5057PK and EH-5030S, all of which are available from ADEKA (CHINA) Co., Ltd; Aradur 3088 available from Huntsman; and ANCAMINE 2441 available from Evonik. Preferably, the epoxy-adduct polyamine is selected from the group consisting of EH-4357S, EH-5057PK and EH-5030S, all of which are available from ADEKA (CHINA) Co., Ltd. More preferably, the epoxy-adduct polyamine is EH-5057PK available from ADEKA (CHINA) Co., Ltd.

Preferably, the amount of the component (e-1) is from 1 to 10 wt. %, preferably from 2 to 8 wt. %, and more preferably from 2.5 to 7 wt. %, each based on the total weight of the composition. When the amount of component (e-1) is within the above ranges, the composition prepared therefrom has a better curing and adhesive force under thermal curing conditions.

(e-2) Microcapsule Type Hardener for an Epoxy Resin Comprising a Core and a Shell

According to the present invention, the thermal- and UV-curable (meth)acrylate composition comprises (e-2) a microcapsule type hardener for an epoxy resin comprising a core and a shell.

Preferably, in the component (e-2), said core comprises at least one hardener for an epoxy resin, and said shell contains a synthetic resin or an inorganic oxide. More preferably, the at least one hardener for an epoxy resin comprises an amine adduct and a low molecular weight amine compound as major components, wherein the molecular weight distribution of the amine adduct, which is defined by the ratio of the weight average molecular weight and the number average molecular weight, is 3 or lower, and the content of the low molecular weight amine compound is 0.001 to 1 part by mass, based on 100 parts by mass of the amine adduct.

The amine adduct used in the present invention is a compound having an amino group obtainable by a reaction between at least one kind of a compound selected from the group consisting of a carboxylic acid compound, a sulfonic acid compound, an isocyanate compound, a urea compound and an epoxy resin; and an amine compound. Preferably, the amine adduct is obtained by a reaction between an epoxy resin and an amine compound.

The low molecular weight amine compound used in the present invention includes a compound having a primary amino group, a secondary amine group and/or a tertiary amino group. Preferably, the low molecular weight amine compound is a compound having a tertiary amino group, preferably an imidazole, and more preferably, 2-methylimidazole and/or 2-ethyl-4-methylimidazole.

The shell used in the present invention contains a synthetic resin or an inorganic oxide, and preferably contains a synthetic resin. Examples of synthetic resins include, but are not limited to: an epoxy resin, a polyester resin, a polyethylene resin, a nylon resin, a polystyrene resin, and a urethane resin, and preferably a urethane resin as an addition product of mono or polyhydric alcohol and mono or polyisocyanate; and a reaction product of an amine hardener and an epoxy resin; and a phenolic resin. Among these, a reaction product between an amine hardener and an epoxy resin is preferable. Examples of inorganic oxides include, but are not limited to: a boron compound such as boron oxide and a borate ester, silicon dioxide and calcium oxide. Among these, boron oxide is preferable.

Examples of commercially available microcapsule type hardeners for an epoxy resin comprising a core and a shell include, but are not limited to: HXA3722, HXA5911 and HXA5923, all of which are available from Asahi Kasei Corporation. Preferably, the microcapsule type hardener is selected from the group consisting of HXA5911 and HXA5923, both of which are available from Asahi Kasei Corporation. More preferably, the microcapsule type hardener is HXA5923 available from Asahi Kasei Corporation.

Preferably, the amount of the component (e-2) is from 1 to 10 wt. %, preferably from 3 to 9 wt. %, and more preferably from 4 to 8.5 wt. %, each based on the total weight of the composition. When the amount of component (e-2) is within the above ranges, the composition prepared therefrom has a better low-temperature curing performance.

(e-3) Urea-Modified Imidazole

According to the present invention, the thermal- and UV-curable (meth)acrylate composition comprises (e-3) a urea-modified imidazole. Preferably, the component (e-3) is prepared by reacting with heating
(e-3-1) an aminoalkylimidazole of the general formula (II):

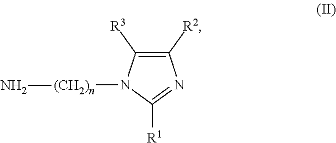

wherein R¹ is a hydrogen atom, an alkyl group or an aryl group, R² is a hydrogen atom or an alkyl group, R³ is a hydrogen atom or an alkyl group, and n is an integer of two or three,
(e-3-2) an amine having two nitrogen atoms with one or two active hydrogen atoms and having at least one cyclic structure group in the molecule thereof,
(e-3-3) urea, and
(e-3-4) a diepoxide having two epoxy groups on average in the molecule thereof.

As examples of the aminoalkylimidazole (e-3-1), there may be mentioned 1-(2-aminoethyl)-2-methylimidazole, 1-(2-aminoethyl)-2-ethylimidazole, 1-(3-aminopropyl) imidazole, 1-(3-aminopropyl)-2-methylimidazole, 1-(3-aminopropyl)-2-ethylimidazole, 1-(3-aminopropyl)-2-phenylimidazole, 1-(3-aminopropyl)-2-heptadecylimidazole, 1-(3-aminopropyl)-2,4-dimethylimidazole, 1-(3-aminopropyl)-2,5-dimethylimidazole, 1-(3-aminopropyl)-2-ethyl-4-methylimidazole, 1-(3-aminopropyl)-2-ethyl-5-methylimidazole, 1-(3-aminopropyl)-4-methyl-2-undecylimidazole, 1-(3-aminopropyl)-5-methyl-2-undecylimidazole, and the like. Of the above compounds, 1-(2-aminoethyl)-2-methylimidazole is particularly preferred.

As the amine (e-3-2) having two nitrogen atoms with one or two active hydrogen atoms and having at least one cyclic structure group in the molecule thereof, there may be mentioned polyamines such as metaxylylenediamine, 1,3-bis-(aminomethyl)cyclohexane, isophoronediamine, diaminocyclohexane, phenylenediamine, tolylenediamine, diaminodiphenylmethane, diaminodiphenyl sulfone, piperazine, N-aminoethylpiperidine, or the like. Of these amine components, isophoronediamine is particularly preferred.

A group “nitrogen atom with one or two active hydrogen atoms” as used herein means a primary amino group (—NH₂) and secondary amino group (—NHR).

The cyclic structure group may be an aromatic group have 6-12 carbon atoms, such as phenyl, naphthyl, biphenyl, diphenyl methyl, or diphenyl sulfone group; a cycloalkyl group having 5-8 carbon atoms, such as cyclopentyl, cyclohexyl, cycloheptyl, or cyclooctyl group; or 5-membered to 8-membered saturated heterocyclic group having at least one nitrogen atom and optionally one or more oxygen or sulfur atoms such as pyrazolidinyl, piperidinyl or piperazinyl group.

As the diepoxide (e-3-4) used in the preparation of the above component (e-3), diepoxide compound having two epoxy groups on average in the molecule thereof may be selected from the following epoxide compounds having more than one epoxy group on average in the molecule thereof: glycidyl ethers obtained by reacting epichlorohydrin with a polyhydric phenol such as bisphenol A, bisphenol F, bisphenol S, hexahydrobisphenol A, tetramethylbisphenol A, tetramethylbisphenol F, catechol, resorcinol, cresol novolak, tetrabromobisphenol A, trihydroxybiphenyl, benzophenone, bis-resorcinol, bisphenol hexafluoroacetone, hydroquinone, triphenylmethane, tetraphenylethane or bixylenol; polyglycidyl ethers obtained by reacting epichlorohydrin with an aliphatic polyhydric alcohol such as glycerin, neopentyl glycol, ethylene glycol, propylene glycol, butylene glycol, hexylene glycol, polyethylene glycol, polypropylene glycol; glycidyl ether esters obtained by reacting epichlorohydrin with a hydroxycarboxylic acid such as p-hydroxybenzoic acid, beta-hydroxynaphthalene carboxylic acid; polyglycidyl esters obtained from a polycarboxylic acid such as phthalic, methylphthalic, isophthalic, telephthalic, tetrahydrophthalic, hexahydrophthalic, endomethylenetetrahydrophthalic, endomethylenehexahydrophthalic, trimellitic or polymerized fatty acid; glycidylaminoglycidyl ethers obtained from aminophenol or aminoalkylphenol; glycidylaminoglycidyl ester obtained from aminobenzoic acid, glycidylamines obtained from aniline, toluidine, tribromoaniline, xylylenediamine, diaminocyclohexane, bisaminomethylcyclohexane, 4,4′-diaminodiphenylmethane, 4,4′-diaminodiphenyl sulfone or the like; for example, epoxypolyolefin, glycidylhydantoin, glycidylalkylhydantoin, triglycidyl cyanurate, butylglycidyl ether, phenylglycidyl ether, alkylphenylglycidyl ether, glycidyl ester of benzoic acid, styrene oxide or the like; or mixtures thereof. Of these epoxides, a bisphenol A type diepoxide having an epoxy equivalent weight of about 190, and a bisphenol F type diepoxide having an epoxy equivalent weight of about 175, are particularly preferred.

The component (e-3) used in the present invention may be synthesized basically as follows. An addition reaction of the amine (e-3-2) having two nitrogen atoms with one or two active hydrogen atoms and having at least one cyclic structure group in the molecule, and the diepoxide (e-3-4) having two epoxy groups on average in the molecule is carried out at preferably 50 to 150° C., more preferably 80 to 130° C., for 1 to 3 hours. Subsequently, the aminoalkylimidazole (e-3-1) and urea (e-3-3) are added thereto, and a deammoniation reaction is carried out at preferably 150 to 240° C., more preferably 160 to 220° C., for 1 to 5 hours. The resulting product is solid and may be pulverized into a desired particle size.

In the component (e-3) prepared by reacting the aminoalkylimidazole (e-3-1), the amine (e-3-2) having two nitrogen atoms with one or two active hydrogen atoms and having at least one cyclic structure group in the molecule, urea (e-3-3), and the diepoxide (e-3-4) having two epoxy groups on average in the molecule, the molar ratio [(e-3-2)/(e-3-1)] of the amine (e-3-2) to the aminoalkylimidazole (e-3-1) is preferably 0.4:1 to 12.0:1, more preferably 0.5:1 to 10.0:1.

The molar ratio of urea (e-3-3) to the sum of the nitrogen atoms with two active hydrogen atoms in the aminoalkylimidazole (e-3-1) and the nitrogen atoms with one or two active hydrogen atoms in the amine (e-3-2) is preferably 0.1:1 to 0.6:1, more preferably 0.2:1 to 0.5:1 with respect to a molar ratio of urea (e-3-3) per one nitrogen atom. The chemical equivalent ratio of the diepoxide (e-3-4) to the sum of the nitrogen atoms with two active hydrogen atoms in the aminoalkylimidazole (e-3-1) and the nitrogen atoms with one or two active hydrogen atoms in the amine (e-3-2) is preferably 0.01:1 to 0.6:1, preferably 0.02:1 to 0.5:1, with respect to a chemical equivalent ratio of the diepoxide (e-3-4) per one nitrogen atom. In addition, a ratio of the sum of the number of the —NH₂ groups in urea (e-3-3) and the number of the epoxy groups in the diepoxide (e-3-4) to the sum of the nitrogen atoms with two active hydrogen atoms in the aminoalkylimidazole (e-3-1) and the nitrogen atoms with one or two active hydrogen atoms in the amine (e-3-2) is preferably 0.8:1 to 1.4:1 per one nitrogen atom.

Examples of commercially available urea-modified imidazoles include, but are not limited to FXR-1081 and FXR-1061, both of which are available from ToKa CO., LTD; and GY3301, available from Guangdong Guyan Electronic Materials Co., Ltd. Preferably, the urea-modified imidazole is selected from the group consisting of FXR-1081 and FXR-1061, both of which are available from ToKa CO., LTD. More preferably, the urea-modified imidazole is FXR-1061 available from ToKa CO., LTD.

Preferably, the amount of the component (e-3) is from 0.1 to 5 wt. %, preferably from 0.2 to 3 wt. %, and more preferably from 0.4 to 2.5 wt. %, each based on the total weight of the composition. When the amount of component (e-3) is within the above ranges, the composition prepared therefrom has a better curing performance at the low temperature and has a better storage stability.

### (F) Additive

In some embodiments of the present invention, the thermal- and UV-curable (meth)acrylate composition may further optionally comprise (F) additives which are commonly used in the art to which the present invention belongs, such as a UV stabilizer, a coupling agent, a heat stabilizer, a filler, and a pigment, as long as they do not negatively affect the desired technical effects of the inventive composition. Preferably, the thermal- and UV-curable (meth)acrylate composition according to the present invention further comprises an additive (F) selected from the group consisting of a UV stabilizer, a coupling agent, a heat stabilizer, a filler, a pigment and combinations thereof. The presence, the type and the amount of the additive can be determined by a specialist in the art according to actual requirements.

In a second aspect, the present disclosure is directed to a method for preparing the thermal- and UV-curable (meth)acrylate composition according to the present invention, comprising: (1) firstly, adding the components (A) to (D), and some or all of the component (F), if any, into a container, and mixing and defoaming the resultant mixture; (2) then, adding the components (e-1) and (e-2) into the container, and mixing and defoaming the resultant mixture; and optionally, adding the remainder of the component (F), if any, into the container, and mixing and defoaming the resultant mixture; and (3) finally, adding the component (e-3) into the container, and mixing and defoaming the resultant mixture, to obtain the thermal- and UV-curable (meth)acrylate composition.

The thermal- and UV-curable (meth)acrylate composition according to the present invention may be prepared by any conventional preparation methods in the art. Preferably, the composition according to the present invention may be prepared by a method comprising the following steps: (1) firstly, adding the components (A) to (D), and some or all of the component (F), if any, into a container, and mixing and defoaming the resultant mixture; (2) then, adding the components (e-1) and (e-2) into the container, and mixing and defoaming the resultant mixture; and optionally, adding the remainder of the component (F), if any, into the container, and mixing and defoaming the resultant mixture; and (3) finally, adding the component (e-3) into the container, and mixing and defoaming the resultant mixture, to obtain the thermal- and UV-curable (meth)acrylate composition. The preparation of the composition is preferably carried out at a controlled temperature; and more preferably, the preparation is carried out at a temperature of from 20 to 30° C. The mixer used in the preparation may be any conventional mixing device used in the art.

In a third aspect, the present disclosure is directed to a method for curing the thermal- and UV-curable (meth)acrylate composition according to the present invention, comprising: (1) irradiating the composition with UV to obtain a pre-cured composition, and then (2) curing the pre-cured composition by heating.

In the step (1), the composition may be irradiated with UV rays having wavelengths from 150 to 400 nm, preferably from 200 to 400 nm, and more preferably from 250 to 400 nm. Examples of the UV light sources used in the present invention include UV-LED lamps, high-pressure mercury lamps, ultra-high pressure mercury lamps, low-pressure mercury lamps, metal halide lamps, carbon ark lamps, and xenon lamps. Preferably, the irradiation energy density is from 2 to 5000 mJ/cm², more preferably from 10 to 3500 mJ/cm², even more preferably from 100 to 3500 mJ/cm².

Preferably, the intensity of illumination is from 0.1 to 5000 mW/cm², more preferably from 1 to 2000 mW/cm². Generally, the UV irradiation is performed for 0.5 to 60 seconds, and preferably for 0.5 to 30 seconds.

In the step (2), there is no particular limitation to the heating conditions, and various known conditions may be adopted. In an embodiment of the present invention, the heating may also be performed at a temperature above 65° C. for 5 to 60 minutes, such as 80° C. for 10 minutes and 70° C. for 30 minutes. Preferably, the heating is performed at a temperature equal to or lower than 65° C. for 30 to 120 minutes, more preferably for 50 to 100 minutes. For example, a heat circulation-type oven may be used as the heating means.

In a fourth aspect, the present disclosure is directed to a cured product obtained from the thermal- and UV-curable (meth)acrylate composition according to the present invention or by the curing method according to the present invention; and an article comprising the cured product, which is preferably a camera.

In a fifth aspect, the present disclosure is directed to a use of the thermal- and UV-curable (meth)acrylate composition according to the present invention or the cured product according to the present invention in assembling a camera module.

The thermal- and UV-curable (meth)acrylate composition according to the present invention is preferably used in a camera module. More specifically, the thermal- and UV-curable (meth)acrylate composition according to the present invention is preferably used in assembling a camera module to adhere a lens holder to a substrate having an image sensor fixed thereon. The camera module is not particularly limited, and is, for example, a compact camera module used for a smartphone or other such device.

The thermal- and UV-curable (meth)acrylate composition according to the present invention, which utilizes a specific combination of three kinds of catalysts (i.e. the components (e-1), (e-2) and (e-3)) in an epoxy-(meth)acrylic/thiol system, can be cured at a low temperature such as 65° C., achieves a good balance between the curing performance at the low temperature and the storage stability at room temperature, and shows good anti-aging properties; and in particular, it achieves a curing ratio higher than 90% within one hour at 65° C., ensures a viscosity growth rate equal to or lower than 30% after three days at 25° C., preferably a viscosity growth rate equal to or lower than 30% after more than three days at 25° C., and shows a ratio of the decrease in the adhesion after a double 85 test for 240 hours to the initial adhesion, and a ratio of the decrease in the adhesion after a double 85 test for 500 hours to the initial adhesion both of which are lower than 30%.

### EXAMPLES

The following examples are intended to assist one skilled in the art to better understand and practice the present invention. The scope of the invention is not limited by the examples but is defined in the appended claims. All parts and percentages are based on weight unless otherwise stated.

### Raw Materials:

### Component (A):

Component a-1: jER-828US, a bisphenol A-type, liquid epoxy resin, available from Mitsubishi Chemical Corporation.

### Component (B):

Component b-1: SR833S, tricyclodecane dimethanol diacrylate, available from Sartomer.

Component b-2: CD535, dicyclopentandienyl methacrylate, available from Sartomer.

### Component (C):

Component c-1: OMNIRAD 2100, available from IGM Resins.

### Component (D):

Component d-1: Multhiol K-3, 1,3,5-tris(3-mercaptopropyl)-1,3,5-triazine-2,4,6 (1H,3H,5H)-trione, available from SC Organic Chemical Co., Ltd.

### Component (E):

Component (e-1):

Component e-1: EH-5057PK, an epoxy-adduct polyamine, available from ADEKA (CHINA) Co., Ltd.

Component (e-2):

Component e-2: HXA5923, a microcapsule type hardener, available from Asahi Kasei Corporation.

Component (e-3):

Component e-3: FXR-1061, a urea-modified imidazole, available from ToKa CO., LTD.

Component e-3′: 2-MZ, 2-methylimidazole, available from Shikoku

### Chemical Corporation.

Component e-3″: Ajicure PN-H, an imidazole adduct latent curing agent, available from Ajinomoto Fine-Techno Co., Inc.

### Component (F):

Component f-1: Tempo, a UV stabilizer, available from Aladdin.

Component f-2: KBM9659, a tris-(trimethoxysilylpropyl) isocyanurate silane coupling agent, available from Shin-Etsu Chemical Co. Ltd.

Component f-3: PM182, a heat stabilizer, available from Henkel (Yantai) New Materials Co., Ltd.

Component f-4: Cab-O-Sil TS-720 fumed silica, a filler, available from Cabot.

Component f-5: 13M, a pigment, available from Mitsubishi Materials Electronic Chemical Co., Ltd.

### Preparation of Examples 1-6 (Ex. 1 to Ex. 6) and Comparative Examples 1 to 12 (CEx. 1 to CEx. 12)

Specific amounts and types of components in the thermal- and UV-curable (meth)acrylate compositions of Examples 1 to 6 according to the present invention and Comparative Examples 1 to 12 are shown in Tables 1 to 3 as below. The compositions were prepared as follows: (1) firstly, adding the components (A) to (D), and the components f-1, f-2, f-3 and f-5, into a 100 mL container, and mixing and defoaming the resultant mixture at 1500 rpm for 3 minutes; (2) then, adding the components (e-1) and (e-2) into the container, and mixing and defoaming the resultant mixture at 1200 rpm for 3 minutes; and then adding the component f-4 into the container, and mixing and defoaming the resultant mixture at 1200 rpm for 3 minutes; and (3) finally, adding the component (e-3) into the container, and mixing and defoaming the resultant mixture at 1200 rpm for 3 minutes, to obtain the thermal- and UV-curable (meth)acrylate composition. The preparation of the compositions was carried out at 25° C. The mixer used in the preparation was Speedmix.

### Test Methods:

### Curing Ratio (65° C./60 Min)

For each of the compositions of Ex. 1 to Ex. 6 and CEx. 1 to CEx. 12, a sample of 5 to 10 mg was weighed into a DSC aluminium sample pan. Total heating value (H₀) and residual heating value (Hₜ) were measured from the uncured sample and cured sample (which was cured at 65° C. for 60 min), respectively, via differential scanning calorimetric (DSC) using a TA instruments DSC Q2000 apparatus, during which the sample was heated up to 250° C. from 40° C. at a heating rate of 10° C./minute. The curing ratio was calculated according to the following equation:

$$Curing ratio ( \% ) = ( Ho - Ht ) * 100 / Ho$$

wherein Ho: Total Heating Value
   Ht: Residual Heating Value

In the present invention, a thermal- and UV-curable (meth)acrylate composition which achieves a curing ratio higher than 90% within one hour at 65° C. is desired.

### Pot Life (25° C.)

For each of the compositions of Ex. 1 to Ex. 6 and CEx. 1 to CEx. 12, viscosity was measured with a rheometer physical MCR302 from the company Anton Paar using a standardized measuring cone PP20 at 25° C. with a 60 μm gap and at a shear rate of 20/second. To assess the storage stability at room temperature, the viscosity was measured repeatedly. When the increase in viscosity over a period is more than 30% when the composition was stored at room temperature, the days was recorded.

In the present invention, a thermal- and UV-curable (meth)acrylate composition which shows a viscosity growth rate equal to or lower than 30% after three days at 25° C. is desired, preferably a viscosity growth rate equal to or lower than 30% after more than three days at 25° C.

a Ratio of the Decrease in the Adhesion after a Double 85 Test for 240 Hours to the Initial Adhesion & a Ratio of the Decrease in the Adhesion after a Double 85 Test for 500 Hours to the Initial Adhesion

For each of the compositions of Ex. 1 to Ex. 6 and CEx. 1 to CEx. 12, a sample of 5.5 mg was dispensed on a PA substrate NTB982 available from Baiside (19.8 mm*19.8 mm) at a width of 600 to 800 μm with a Musashi 350PC to form a hollow square, thereafter an LCP (Liquid Crystal Polymer) die VL96AC available from Otsuka Chemical Co. Ltd (10 mm*10 mm) was mounted thereon, and the bond line thickness (BLT) of the sample was adjusted to be 150 μm. Irradiation with a 365 nm LED was performed from four circumferential directions (1000 mW/cm²*2.1 seconds) for temporary curing. Therefore, the sample was cured by heating at 65° C. for 60 minutes in a hot-air circulation oven, and subjected to measurement at a shear speed of 200 μm/s at a shear height of 120 μm using a bond tester (4000 Optima, produced by Dage), and the value obtained was recorded as initial adhesion. Reliability tests were conducted under the conditions of 85° C. and 85% RH for 240 hours and 500 hours, respectively; and the values obtained were recorded as adhesion after a double 85 test for 240 hours and adhesion after a double 85 test for 500 hours, respectively.

The ratio of the decrease in the adhesion after a double 85 test for 240 hours to the initial adhesion and the ratio of the decrease in the adhesion after a double 85 test for 500 hours to the initial adhesion were calculated as follows:

The ratio of the decrease in the adhesion after a double 85 test for 240 hours to the initial adhesion was calculated according to the following equation:

$$Decrease ratio after 240 h = ( the initial adhesion - the adhesion after a double 85 test for 240 hours ) / the initial adhesion$$

The ratio of the decrease in the adhesion after a double 85 test for 500 hours to the initial adhesion was calculated according to the following equation:

$$Decrease ratio after 500 h = ( the initial adhesion - the adhesion after a double 85 test for 500 hours ) / the initial adhesion$$

In the present invention, a thermal- and UV-curable (meth)acrylate composition which shows a ratio of the decrease in the adhesion after a double 85 test for 240 hours to the initial adhesion, and a ratio of the decrease in the adhesion after a double 85 test for 500 hours to the initial adhesion, both of which are lower than 30% is desired.

The curing ratio (65° C./60 min), the pot life (25° C.), the ratio of the decrease in the adhesion after a double 85 test for 240 hours to the initial adhesion, and the ratio of the decrease in the adhesion after a double 85 test for 500 hours to the initial adhesion of the compositions were tested using the methods stated above respectively, and the results thereof are shown in Tables 1-3 as below.

TABLE 1

| | | Ex. 1 | Ex. 2 | Ex. 3 | Ex. 4 | Ex. 5 | Ex. 6 |
|---|---|---|---|---|---|---|---|
| Components (weight in g) | | | | | | | |
| (A) | a-1 | 15.43 | 15.43 | 15.43 | 15.43 | 15.43 | 15.43 |
| (B) | b-1 | 15.90 | 15.90 | 15.90 | 15.90 | 15.90 | 15.90 |
| | b-2 | 9.74 | 9.74 | 9.74 | 9.74 | 9.74 | 9.74 |
| (C) | c-1 | 2.76 | 2.76 | 2.76 | 2.76 | 2.76 | 2.76 |
| (D) | d-1 | 29.37 | 29.37 | 29.37 | 29.37 | 29.37 | 29.37 |
| (E) | e-1 | 6.00 | 6.00 | 6.00 | 5.00 | 4.00 | 3.00 |
| | e-2 | 5.00 | 6.00 | 6.48 | 6.00 | 7.00 | 8.00 |
| | e-3 | 1.98 | 0.98 | 0.50 | 1.98 | 1.98 | 1.98 |
| (F) | f-1 | 0.03 | 0.03 | 0.03 | 0.03 | 0.03 | 0.03 |
| | f-2 | 2.76 | 2.76 | 2.76 | 2.76 | 2.76 | 2.76 |
| | f-3 | 2.43 | 2.43 | 2.43 | 2.43 | 2.43 | 2.43 |
| | f-4 | 8.11 | 8.11 | 8.11 | 8.11 | 8.11 | 8.11 |
| | f-5 | 0.49 | 0.49 | 0.49 | 0.49 | 0.49 | 0.49 |

| | | | | | | |
|---|---|---|---|---|---|---|
| Total weight of the | 100.0 | 100.0 | 100.0 | 100.0 | 100.0 | 100.0 |
| composition (in g) | | | | | | |
| Weight ratio of e-2 to e-3 | 2.5 | 6.1 | 13.0 | 3.0 | 3.5 | 4.0 |
| Test results | | | | | | |
| Curing ratio (65° C./60 min) | 96.0% | 95.0% | 93.0% | 96.4% | 97.2% | 92.0% |
| Pot life (25° C.) | Viscosity | Viscosity | Viscosity | Viscosity | Viscosity | Viscosity |
| | increase | increase | increase | increase | increase | increase |
| | 30% after | 30% after | 30% after | 28% after | 25% after | 30% after |
| | 3 days | 4 days | 7 days | 3 days | 3 days | 5 days |
| Initial Adhesion (in Kg) | 24.4 | 22.5 | 21.1 | 24.1 | 26.5 | 27.4 |
| Adhesion after D85 240 h | 21.4 | 19.2 | 17.6 | 22.4 | 24.5 | 25.1 |
| (in Kg) | | | | | | |
| Decrease ratio after 240 h | 12.3% | 14.7% | 16.6% | 7.1% | 7.6% | 8.4% |
| Adhesion after D85 500 h | 20.0 | 17.0 | 16.0 | 20.0 | 22.0 | 21.0 |
| (in Kg) | | | | | | |
| Decrease ratio after 500 h | 18.0% | 24.4% | 24.2% | 17.0% | 17.0% | 24.0% |

TABLE 2

| | | CEx. 1 | CEx. 2 | CEx. 3 | CEx. 4 | CEx. 5 | CEx. 6 |
|---|---|---|---|---|---|---|---|
| Components (weight in g) | | | | | | | |
| (A) | a-1 | 15.43 | 15.43 | 15.43 | 15.43 | 15.43 | 15.43 |
| (B) | b-1 | 15.90 | 15.90 | 15.90 | 15.90 | 15.90 | 15.90 |
| | b-2 | 9.74 | 9.74 | 9.74 | 9.74 | 9.74 | 9.74 |
| (C) | c-1 | 2.76 | 2.76 | 2.76 | 2.76 | 2.76 | 2.76 |
| (D) | d-1 | 29.37 | 29.37 | 29.37 | 29.37 | 29.37 | 29.37 |
| (E) | e-1 | 12.98 | 0 | 0 | 7.98 | 7.98 | 0 |
| | e-2 | 0 | 12.98 | 0 | 5.00 | 0 | 7.98 |
| | e-3 | 0 | 0 | 12.98 | 0 | 5.00 | 5.00 |
| (F) | f-1 | 0.03 | 0.03 | 0.03 | 0.03 | 0.03 | 0.03 |
| | f-2 | 2.76 | 2.76 | 2.76 | 2.76 | 2.76 | 2.76 |
| | f-3 | 2.43 | 2.43 | 2.43 | 2.43 | 2.43 | 2.43 |
| | f-4 | 8.11 | 8.11 | 8.11 | 8.11 | 8.11 | 8.11 |
| | f-5 | 0.49 | 0.49 | 0.49 | 0.49 | 0.49 | 0.49 |

| | | | | | | |
|---|---|---|---|---|---|---|
| Total weight of the | 100.0 | 100.0 | 100.0 | 100.0 | 100.0 | 100.0 |
| composition (in g) | | | | | | |
| Test results | | | | | | |
| Curing ratio (65° C./60 min) | 55.0% | 65.0% | 85.0% | 87.0% | 88.0% | 70.0% |
| Pot life (25° C.) | Viscosity | Viscosity | Viscosity | Viscosity | Viscosity | Viscosity |
| | increase | increase | increase | increase | increase | increase |
| | 30% after | 30% after | 30% after | 30% after | 30% after | 30% after |
| | 7 days | 12 days | 1 day | 9 days | 2 days | 2 days |
| Initial Adhesion (in Kg) | 8.2 | 10.7 | 12.3 | 11.2 | 12.5 | 8.2 |
| Adhesion after D85 240 h | 3.5 | 4.7 | 4.8 | 4.6 | 5.4 | 3.4 |
| (in Kg) | | | | | | |
| Decrease ratio after 240 h | 57.3% | 56.1% | 61.0% | 58.9% | 56.8% | 58.5% |
| Adhesion after D85 500 h | 2.6 | 3.0 | 3.2 | 3.0 | 2.8 | 2.0 |
| (in Kg) | | | | | | |
| Decrease ratio after 500 h | 68.3% | 72.0% | 74.0% | 73.2% | 77.6% | 75.6% |

TABLE 3

| | | CEx. 7 | CEx. 8 | CEx. 9 | CEx. 10 | CEx. 11 | CEx. 12 |
|---|---|---|---|---|---|---|---|
| Components (weight in g) | | | | | | | |
| (A) | a-1 | 15.43 | 15.43 | 15.43 | 15.43 | 15.43 | 15.43 |
| (B) | b-1 | 15.90 | 15.90 | 15.90 | 15.90 | 15.90 | 15.90 |
| | b-2 | 9.74 | 9.74 | 9.74 | 9.74 | 9.74 | 9.74 |
| (C) | c-1 | 2.76 | 2.76 | 2.76 | 2.76 | 2.76 | 2.76 |
| (D) | d-1 | 29.37 | 29.37 | 29.37 | 29.37 | 29.37 | 29.37 |
| (E) | e-1 | 6.00 | 7.00 | 8.00 | 9.00 | 6.00 | 6.00 |
| | e-2 | 4.00 | 4.00 | 3.00 | 2.00 | 5.00 | 5.00 |
| | e-3 | 2.98 | 1.98 | 1.98 | 1.98 | 0 | 0 |
| | e-3′ | 0 | 0 | 0 | 0 | 1.98 | 0 |
| | e-3″ | 0 | 0 | 0 | 0 | 0 | 1.98 |
| (F) | f-1 | 0.03 | 0.03 | 0.03 | 0.03 | 0.03 | 0.03 |
| | f-2 | 2.76 | 2.76 | 2.76 | 2.76 | 2.76 | 2.76 |
| | f-3 | 2.43 | 2.43 | 2.43 | 2.43 | 2.43 | 2.43 |
| | f-4 | 8.11 | 8.11 | 8.11 | 8.11 | 8.11 | 8.11 |
| | f-5 | 0.49 | 0.49 | 0.49 | 0.49 | 0.49 | 0.49 |

| | | | | | | |
|---|---|---|---|---|---|---|
| Total weight of the | 100.0 | 100.0 | 100.0 | 100.0 | 100.0 | 100.0 |
| composition (in g) | | | | | | |
| Weight ratio of e-2 to e-3 | 1.3 | 2.0 | 1.5 | 1.0 | / | / |
| Test results | | | | | | |
| Curing ratio (65° C./60 min) | 98.0% | 95.7% | 95.1% | 93.1% | 91.0% | 80.0% |
| Pot life (25° C.) | Viscosity | Viscosity | Viscosity | Viscosity | Viscosity | Viscosity |
| | increase | increase | increase | increase | increase | increase |
| | 30% after | 31% after | 33% after | 40% after | 40% after | 44% after |
| | 2 days | 3 days | 3 days | 3 days | 1 day | 1 day |
| Initial Adhesion (in Kg) | 22.1 | 23.5 | 21.6 | 20.1 | 14.4 | 9.4 |
| Adhesion after D85 240 h | 18.0 | 20.4 | 19.2 | 17.3 | 6.4 | 5.2 |
| (in Kg) | | | | | | |
| Decrease ratio after 240 h | 18.6% | 13.2% | 11.1% | 13.9% | 55.6% | 44.7% |
| Adhesion after D85 500 h | 16.8 | 18.0 | 17.0 | 16.0 | 4.8 | 4.0 |
| (in Kg) | | | | | | |
| Decrease ratio after 500 h | 24.0% | 23.4% | 21.3% | 20.4% | 66.7% | 57.5% |

From the data in Table 1, it can be seen that the thermal- and UV-curable (meth)acrylate composition according to the present invention (Ex. 1 to Ex. 6), which utilizes a specific combination of three kinds of catalysts (i.e. the components (e-1), (e-2) and (e-3)) in an epoxy-(meth)acrylic/thiol system, can be cured at a low temperature such as 65° C., achieves a good balance between the curing performance at the low temperature and the storage stability at room temperature, and shows good anti-aging properties; and in particular, it achieves a curing ratio higher than 90% within one hour at 65° C., ensures a viscosity growth rate equal to or lower than 30% after three days at 25° C., and shows a ratio of the decrease in the adhesion after a double 85 test for 240 hours to the initial adhesion, and a ratio of the decrease in the adhesion after a double 85 test for 500 hours to the initial adhesion both of which are lower than 30%.

In contrast, the (meth)acrylate compositions which are not according to the present invention (CEx. 1 to CEx. 12) did not achieve a curing ratio higher than 90% within one hour at 65° C., ensure a viscosity growth rate equal to or lower than 30% after three days at 25° C., and show a ratio of the decrease in the adhesion after a double 85 test for 240 hours to the initial adhesion, and a ratio of the decrease in the adhesion after a double 85 test for 500 hours to the initial adhesion both of which are lower than 30% at the same time. For example, all of CEx. 1 to CEx. 3 (merely comprising one of the components e-1, e-2 and e-3 as catalyst) and CEx. 4 to CEx. 6 (merely comprising two of the components e-1, e-2 and e-3 as catalyst) achieved curing ratios which are lower than 90% within one hour at 65° C., some of them cannot ensure a viscosity growth rate equal to or lower than 30% after three days at 25° C., and all of them showed ratios of the decrease in the adhesion after a double 85 test for 240 hours to the initial adhesion, and ratios of the decrease in the adhesion after a double 85 test for 500 hours to the initial adhesion, all of which are higher than 55%. All of CEx. 7 to CEx. 10 (comprising all of the components e-1, e-2 and e-3, but the weight ratios of the component e-2 to the component e-3 were lower than 2.1) cannot ensure a viscosity growth rate equal to or lower than 30% after three days at 25° C. Both of CEx. 11 and CEx. 12 (comprising an imidazole instead of a urea-modified imidazole, i.e. component e-3) cannot ensure a viscosity growth rate equal to or lower than 30% after three days at 25° C., and showed ratios of the decrease in the adhesion after a double 85 test for 240 hours to the initial adhesion, and ratios of the decrease in the adhesion after a double 85 test for 500 hours to the initial adhesion, all of which are higher than 44%; and CEx. 12 achieved a curing ratio within one hour at 65° C. of 80%.

Although some preferred embodiments have been described, many modifications and variations may be made thereto in light of the above teachings. It is therefore to be understood that the invention may be practiced otherwise than as specifically described without departing from the scope of the appended claims.

What is claimed is:

1. A thermal- and UV-curable (meth)acrylate composition comprising:
(A) an epoxy resin,
(B) a (meth)acrylate,
(C) a photoinitiator,
(D) a thiol curing agent, and
(E) a catalyst mixture containing (e-1) an epoxy-adduct polyamine, (e-2) a microcapsule type hardener for an epoxy resin comprising a core and a shell, and (e-3) a urea-modified imidazole, wherein the weight ratio of the component (e-2) to the component (e-3) is not lower than 2.1.

2. The thermal- and UV-curable (meth)acrylate composition according to claim 1, wherein the weight ratio of the component (e-2) to the component (e-3) is from 2.1 to 25.

3. The thermal- and UV-curable (meth)acrylate composition according to claim 1, wherein the component (e-1) is an epoxy adduct of an amine compound obtained from (e-1-1) an amine compound and (e-1-2) an epoxy compound.

4. The thermal- and UV-curable (meth)acrylate composition according to claim 1, wherein in the component (e-2), said core comprises at least one hardener for an epoxy resin, and said shell contains a synthetic resin or an inorganic oxide; wherein the molecular weight distribution of the amine adduct, which is defined by the ratio of the weight average molecular weight and the number average molecular weight, is 3 or lower, and the content of the low molecular weight amine compound is 0.001 to 1 part by mass, based on 100 parts by mass of the amine adduct.

5. The thermal- and UV-curable (meth)acrylate composition according to claim 1, wherein the component (e-3) is prepared by reacting with heating
(e-3-1) an aminoalkylimidazole of the general formula (II): 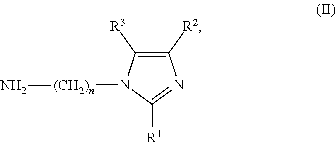
wherein R¹ is a hydrogen atom, an alkyl group or an aryl group, R² is a hydrogen atom or an alkyl group, R³ is a hydrogen atom or an alkyl group, and n is an integer of two or three,
(e-3-2) an amine having two nitrogen atoms with one or two active hydrogen atoms and having at least one cyclic structure group in the molecule thereof,
(e-3-3) urea, and
(e-3-4) a diepoxide having two epoxy groups on average in the molecule thereof.

6. The thermal- and UV-curable (meth)acrylate composition according to claim 1, wherein the amount of the component (e-1) is from 1 to 10 wt. % each based on the total weight of the composition.

7. The thermal- and UV-curable (meth)acrylate composition according to claim 1, wherein the amount of the component (e-2) is from 1 to 10 wt. % each based on the total weight of the composition.

8. The thermal- and UV-curable (meth)acrylate composition according to claim 1, wherein the amount of the component (e-3) is from 0.1 to 5 wt. % each based on the total weight of the composition.

9. The thermal- and UV-curable (meth)acrylate composition according to claim 1, further comprising an additive (F) selected from the group consisting of a UV stabilizer, a coupling agent, a heat stabilizer, a filler, a pigment and combinations thereof.

10. The thermal- and UV-curable (meth)acrylate composition according to claim 1, which is a one-component adhesive.

11. A method for preparing the thermal- and UV-curable (meth)acrylate composition according to claim 1, comprising: (1) firstly, adding the components (A) to (D), and some or all of the component (F), if any, into a container, and mixing and defoaming the resultant mixture; (2) then, adding the components (e-1) and (e-2) into the container, and mixing and defoaming the resultant mixture; and optionally, adding the remainder of the component (F), if any, into the container, and mixing and defoaming the resultant mixture; and (3) finally, adding the component (e-3) into the container, and mixing and defoaming the resultant mixture, to obtain the thermal- and UV-curable (meth)acrylate composition.

12. A method for curing the thermal- and UV-curable (meth)acrylate composition according to claim 1, comprising: (1) irradiating the composition with UV to obtain a pre-cured composition, and then (2) curing the pre-cured composition by heating.

13. A cured product obtained from the thermal- and UV-curable (meth)acrylate composition according to claim 1.

14. An article comprising the cured product according to claim 13, which is a camera.
